(19) United States
(12) Patent Application Publication
(10) Pub. No.: US 2025/0042383 A1
(43) Pub. Date: Feb. 6, 2025

(54) HYDRAULIC MODULE, IN PARTICULAR FOR GENERATING PRESSURE AND/OR CONTROLLING PRESSURE IN A SLIP-CONTROLLABLE BRAKE SYSTEM OF A MOTOR VEHICLE, AND MOUNTING METHOD FOR A HYDRAULIC MODULE

(71) Applicant: Robert Bosch GmbH, Stuttgart (DE)

(72) Inventors: Andreas Weh, Sulzberg (DE); Martin Hagspiel, Rettenberg (DE); Stefan Kaserer, Ofterschwang (DE)

(21) Appl. No.: 18/715,819

(22) PCT Filed: Feb. 3, 2023
(86) PCT No.: PCT/EP2023/052627

§ 371 Date: Jun. 3, 2024

(30) Foreign Application Priority Data
Mar. 3, 2022 (DE) 10 2022 202 162.2

(51) Int. Cl. B60T 17/08; F15B 3/00; F15B 15/14

(52) U.S. Cl. CPC B60T 17/08; F15B 3/00; F15B 15/1452; B60T 2270/10

(57) ABSTRACT

A hydraulic module for generating pressure and/or controlling pressure in a slip-controllable brake system of a motor vehicle. A hydraulic module includes a piston pressure generator including a piston which is displaceably accommodated in a cylinder bore of a housing block and can be driven to perform an axial movement. The piston delimits a working chamber, which changes its volume depending on the movement direction of the piston. A guide gap between a circumference of the piston and the cylinder bore is sealed toward the working chamber using a seal assembly. A guide element is included, on which the piston can be radially supported with its circumference, on a side of the seal assembly that faces away from the working chamber. This guide element is accommodated in a receiving groove of the housing block in such a way that it extends radially in part into the guide gap.

### FIELD

The present invention relates to a hydraulic module, in particular for generating pressure and/or controlling pressure in a slip-controllable brake system of a motor vehicle, and to a mounting method for a hydraulic module.

### BACKGROUND INFORMATION

Below, a hydraulic module according to the present invention is understood to mean a mounting assembly consisting of a housing block, a piston pressure generator arranged on the housing block, and a transmission for driving this piston pressure generator.

The piston pressure generator comprises a piston which is displaceably accommodated in a cylinder bore of the housing block and delimits a working chamber. This piston can be driven by the transmission to perform an axial movement in a pressure increase direction or a pressure decrease direction. A volume of the working chamber decreases when the piston moves in the pressure increase direction, or increases when the piston is actuated oppositely thereto in the pressure decrease direction.

An electrically controllable electric motor comprising a motor shaft whose rotational movement is converted by the transmission into an axial movement of the piston is provided as a drive for the piston. Pressure medium displaced from the working chamber is displaced into a brake circuit connected to the hydraulic module, whereby the pressure level prevailing there rises.

Conversely, the pressure level drops when the piston is actuated in the opposite direction and the volume flows from the brake circuit back to the working chamber.

Preferably, in electronically slip-controllable vehicle brake systems, such hydraulic modules are used to generate and/or control a brake pressure. They inter alia allow a quick and reliable adjustment of the brake pressure of the wheel brakes to the slip ratios of the assigned wheels of the vehicle or make a brake pressure build-up possible if the vehicle enters an unstable driving state or if the traffic situation in the environment of the vehicle requires it in order to prevent an accident.

An actuation of the piston pressure generator is controlled by an electronic control unit and can take place regardless of whether or not a driver of the motor vehicle specifies a braking request. Since the driver is not directly involved in the brake pressure build-up, such brake systems are referred to as power brake systems, in contrast to conventional manual brake systems.

The piston of the piston pressure generator is displaceably accommodated in a cylinder bore of the housing block, as explained. An existing guide gap between the circumference of the piston and the wall of the cylinder bore is sealed toward the working chamber by a seal assembly.

A hydraulic module according to these statements is described in German Patent Application No. DE 10 2019 208 397 A1, for example.

In the conventional hydraulic module, a guide gap between the cylinder bore and the piston circumference is relatively narrow, which has the advantage that this guide gap and thus the working chamber can be sealed well and that a risk of the seal assembly being extruded into this guide gap due to the piston movement and being damaged thereby is extremely low.

It is disadvantageous, however, that the production of narrow guide gaps is comprehensibly more complex from a manufacturing point of view and thus more expensive than the production of wider guide gaps. In addition, tolerance-related dimensional deviations in the production of the piston, cylinder bore, and/or transmission components may result in concentricity errors of the longitudinal axes of these components, in angular errors, and/or in wobbly movement of the driven piston. In conjunction with narrow guide gaps, these errors in their entirety may have the result that the wall of the cylinder bore is contacted by the piston, is thereby loaded with effective radial forces, and wears out.

Although such wear can, for example, be counteracted by a suitable coating of the cylinder bore, such a coating means an additional expense, which negatively affects the production costs of a hydraulic module. Moreover, these boundary conditions have influence on the structural design, the production method, and the material selection for the piston.

### SUMMARY

A hydraulic module having features of the present invention can be produced more cost-effectively than a conventional hydraulic module, with unchanged quality in terms of the piston guidance and the sealing of the working chamber or of the guide gap for the piston. The cost savings are based, on the one hand, on a now radially wider guide gap between the circumference of the piston and the wall of the cylinder bore and, on the other hand, on the possible savings of an elaborate coating of the wall of the cylinder bore and/or of the piston circumference for preventing possibly occurring wear. In addition, it is possible to expand the possibilities for the selection of a material for the piston. For example, a piston made of steel, which can moreover be produced more cost-effectively by forming, can be used in the future. The components of the transmission can now also be manufactured with sufficient quality in a deep-drawing technique.

According to an example embodiment of the present invention, the mentioned advantages are based on using, for the piston, a guide element that is arranged in a housing-side receiving groove on a side of the seal assembly that faces away from the working chamber. This receiving groove is formed along the inner circumference of the cylinder bore and accommodates the guide element in such a way that this guide element projects in part into the guide gap between piston circumference and cylinder bore.

Further advantages or advantageous developments of the present invention result from the disclosure herein.

According to an example embodiment of the present invention, if a form-elastic, diagonally slotted ring with two free and opposite ends is used as the guide element, this guide element can effortlessly be radially preloaded and reduced in its outer diameter when it is being mounted. By means of a mounting sleeve and a punch, the guide element can then be inserted into the cylinder bore and placed in the provided receiving groove without fear of damage. As soon as the guide element is snapped into the provided receiving groove, it is fixedly held or trapped there after the piston is mounted into the cylinder bore.

Due to the reasonable costs, the good frictional properties, and a resistance to brake fluids, a guide element made of PTFE is in particular suitable.

The guide element is axially and radially movably accommodated in the receiving groove and, in conjunction with its form elasticity due to its slotted design, is capable of compensating for tolerance-related wobbly movements of the piston, angular errors, or an axial offset between the components of the piston drive. A contact of the piston with the wall of the cylinder bore is largely excluded.

According to an example embodiment of the present invention, the receiving groove of the guide element is designed to be stepped from the outside to the inside and thereby forms abutment shoulders on which the guide element is radially supportable. These abutment shoulders limit the maximum possible widening of the guide element and thus protect the component from impermissibly high loading or breakage. The maximum deformation of the guide element is limited by the relative position of the abutment shoulders to the longitudinal axis L to a degree that no contact between piston circumference and bore wall takes place over the operating time of the hydraulic module or that the radial forces occurring in the event of a contact do not cause considerable wear on the bore wall or piston.

According to an example embodiment of the present invention, a portion of the receiving groove that is smaller in cross section is located between the abutment shoulders and a groove bottom of this receiving groove. This portion is hydraulically connected to a pressure-medium-conducting region of the housing so that pressure medium flows to a rear side of the guide element that faces away from the piston, and reaches the piston circumference. In order to prevent the pressure medium from penetrating into the interior of the transmission, the guide element is arranged between two seal assemblies in an advantageous development of the present invention. The seal assemblies comprise pressure-loadable sealing lips, which are to be brought by the effective pressure of the pressure medium into abutment on the groove flank, on the groove bottom, or on the housing block and on the piston circumference. The sealing lips of the seal assemblies are lubricated by the pressure medium present and are thus protected from premature wear. In addition, the lubricated seal assemblies ensure a particularly effective sealing of the working chamber with minimal frictional forces inhibiting the piston movement.

### BRIEF DESCRIPTION OF THE DRAWINGS

An exemplary embodiment of the present invention is shown in the figures and explained in greater detail in the subsequent description.

FIG. 1 shows a hydraulic module according to an example embodiment of the present invention in a longitudinal section.

FIG. 2 shows a detail X according to FIG. 1 in an enlargement. This detail shows the arrangement of a guide element in the housing block of the hydraulic module, which forms the basis of the present invention.

FIG. 3 and FIG. 4 illustrate the mounting operation of a guide element according to an example embodiment of the present invention into a receiving groove of the housing of the hydraulic module, wherein FIG. 3 shows a housing block, a mounting sleeve, and a guide element in a 3-dimensional exploded view, while FIG. 4 shows a longitudinal section of a portion of the housing block with the mounting sleeve inserted in the cylinder bore, and guide element inserted therein.

Corresponding components are provided with uniform reference signs in the individual figures.

### DETAILED DESCRIPTION OF EXAMPLE EMBODIMENTS

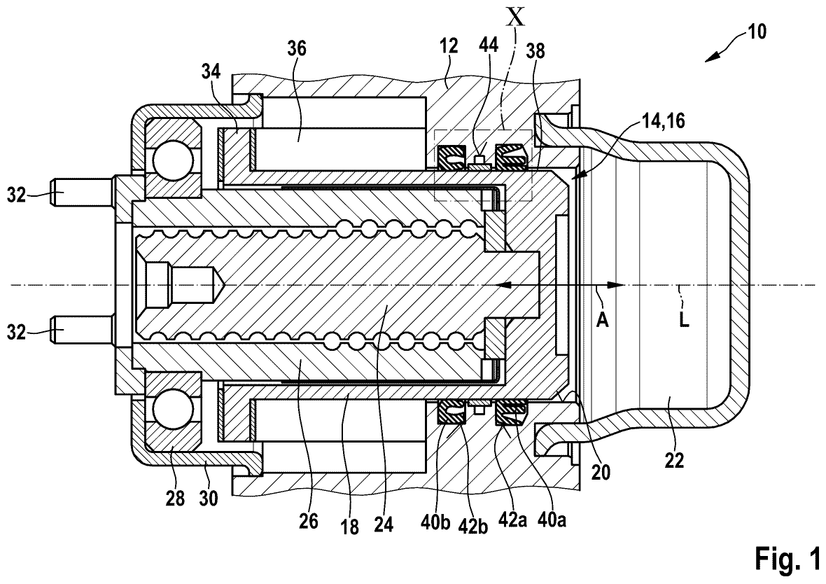

The hydraulic module (10) shown in FIG. 1 comprises a housing block (12) with a piston pressure generator (14) arranged thereon, and a transmission (16) for driving a piston (18) of this piston pressure generator (14). Formed in the housing block (12) is a cylinder bore (20), in which the piston (18) is accommodated and movably guided to perform a back and forth axial movement according to double arrow A. This piston (18) is designed as a hollow piston and, with its closed end or piston bottom, delimits a working chamber (22) filled with hydraulic pressure medium.

In the interior of the hollow piston, the components of the transmission (16) actuating the piston (18) are arranged. These components are a spindle (24) and a spindle nut (26) surrounding this spindle (24). At its end located in the hollow interior of the piston (18), the spindle (24) is connected to this piston (18) in a rotationally fixed manner. To this end, a spindle pin engages in a blind-hole-like pin receptacle on the inner side of the piston bottom and thus produces a force fit between the components.

Mutually assigned and spirally circumferential raceway portions of a ball raceway are formed on the outer circumference of the spindle (24) and on the inner circumference of the spindle nut (26). Circulating balls accommodated in this ball raceway produce a mechanical engagement between the spindle (24) and the spindle nut (26).

The spindle nut (26) is rotatably mounted in the interior of the cylinder bore (20) by a bearing (28). The latter is designed, by way of example, as a rolling bearing and is accommodated in a bearing seat of a bearing shield (30), which bearing shield is anchored circumferentially in the cylinder bore (20) of the housing block (12). The bearing shield (30) has a central recess in which a drive device (32) supported on the inner ring of the rolling bearing and coupled in a rotationally fixed manner to the spindle nut (26) is arranged. According to FIG. 1, this drive device (32) projects leftward from the hydraulic module (10) and is used to transfer a rotational movement, for example from a motor/transmission unit (not shown) to the spindle nut (26).

Support elements (34) opposite one another are formed on the piston (18) at the open end thereof. These support elements project like wings radially outward from the piston (18) and engage in assigned housing-block-side guide grooves (36) extending in the direction of a longitudinal axis L of the cylinder bore (20) in the housing block (12). On the flanks of the guide grooves (36), the support elements (34) are supported in the circumferential direction so that the piston (18) and the spindle (24) coupled thereto cannot follow the rotational movement of the spindle nut (26). As a result, the explained spindle drive or transmission (16) converts a rotational movement of the spindle nut (26) into an axial movement of the piston (18). Depending on the rotation direction, the piston (18) is driven in a pressure increase direction or in a pressure decrease direction opposite thereto. In the pressure increase direction, the piston (18) moves into the working chamber (22) and displaces the pressure medium contained therein into a connected brake circuit (not visible). If the piston (18) moves in a direction opposite thereto, i.e., in the pressure decrease direction, the volume of the working chamber (22) increases and pressure medium flows from the brake circuit back into this working chamber (22) and, accordingly, the pressure level in the connected brake circuit decreases.

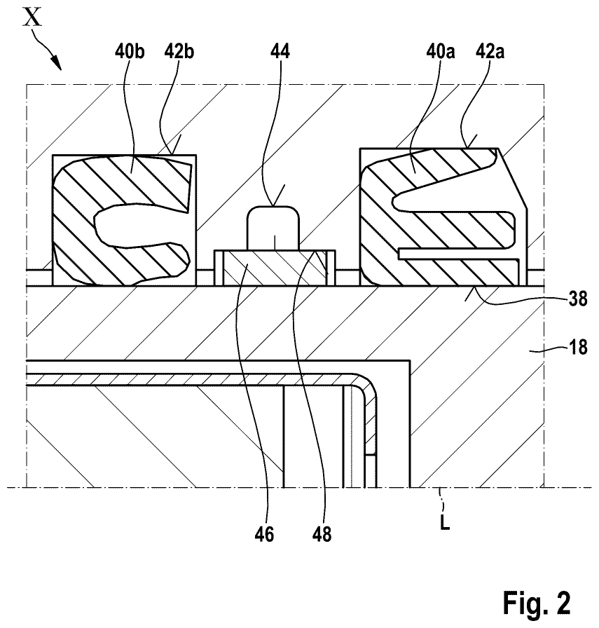

As explained, the piston (18) is guided directly in the housing block (12). For this purpose, a circumferential guide gap (38) is present between a circumference of the piston (18) and a wall of the cylinder bore (20). This guide gap is sealed toward the working chamber (22) in order to make pressure changes in the working chamber (22) through the described axial movement of the piston (18) possible. The taken measures according to the present invention for guiding the piston (18) in the cylinder bore (20) and for sealing the guide gap (38) between piston (18) and cylinder bore (20) are shown in detail X and are explained below on the basis of a detailed description of FIG. 2, which shows this detail X in an enlargement.

In the exemplary embodiment, sealing of the mentioned guide gap (38) toward the working chamber (22) takes place by two seal assemblies (40a; 40b). Both are respectively accommodated in an assigned annular groove (42a, 42b), which are formed at an axial distance from one another on the inner wall of the cylinder bore (20). The first seal assembly (40a), or high-pressure seal, facing the working chamber (20) is designed as a multi-chamber seal ring, the individual chambers of which are open toward the working chamber (22). Pressurized pressure medium from this working chamber (22) can thus penetrate into the chambers and lay or press the seal assembly (40a) onto the flanks of the surrounding annular groove (42a) or onto the piston circumference.

The second seal assembly (40b) is arranged on the side of the first seal assembly (40a) that faces away from the working chamber (22) and is designed as a lip seal ring with two sealing lips. A first sealing lip abuts on the bottom of the annular groove (42b), and a second sealing lip likewise abuts on the piston circumference. With its closed side, the second seal assembly (40b) is axially supported on the flank of the annular groove (42b) that is far from the working chamber.

Between the two annular grooves (42a, 42b) for the seal assemblies (40a, b), a likewise annular receiving groove (44) for accommodating a guide element (46) for the piston (18) is arranged on the wall of the cylinder bore (20). In cross section, this receiving groove (44) is stepped once at a right angle in its radial extension direction, i.e., inward starting from its side that is open toward the piston (18), and is thereby divided into two mutually transitioning groove portions of different axial extent or width. A transition between the groove portions forms abutment shoulders (48), on which the guide element (46) accommodated in the wider groove portion of the receiving groove (44) is supported at the edge, while a center region of it covers the narrower groove portion of the receiving groove (44).

By way of example, the guide element (46) has a rectangular cross section and projects radially in part from the receiving groove (44) into the guide gap (38) between piston (18) and cylinder bore (20). The groove portion of the receiving groove (44) in which the guide element (46) is inserted is wider, when viewed in the direction of the longitudinal axis L of the hydraulic module (10), than the portion of the guide element (46) that projects into this receiving groove (44), so that the guide element is accommodated in the receiving groove (44) with lateral or axial play in both spatial directions.

The narrower groove portion of the receiving groove (44) is located on the side of the abutment shoulders (48) that faces away from the piston (18) and extends in the radial direction between these abutment shoulders (48) and a bottom of the receiving groove (44). This groove portion is connected (not shown in the drawing) to cavities in the housing block (12), in which cavities the pressure medium is at atmospheric pressure. Preferably, these cavities, for example channels or chambers, are connected to a pressure medium reservoir. Pressure medium at atmospheric pressure thus passes through the narrower groove portion of the receiving groove (44) to a rear side of the guide element (46) that faces away from the piston (18).

This guide element (46) is produced from a brake-fluid-resistant material with good sliding properties, for example, from PTFE. It is formed as a singly slotted ring, the free ends of which are opposite one another. A slot S through the guide element (46) runs diagonally to the longitudinal axis L. The end faces of the free ends of the slot S are respectively beveled radially, i.e., from the outside to the inside, in the same direction so that, even at low radial pressure on the circumference of the guide element (46), the two ends slide over one another and, consequently, the outer diameter of the guide element (46) decreases while its radial preload increases. In turn, the slot S, which crosses the guide element (46), also allows a radial widening of the guide element (46), for example if the piston (18) abutting on it acts, during its actuation, with radial forces on the inner circumference due to manufacturing tolerances of the components of the transmission (16). In the installed state, as mentioned, the maximum possible widening of the guide element (46) is limited by the abutment shoulders (48) of the receiving groove (44), whereby the guide element (46) is effectively protected from overloading or damage.

In order to prevent contact of the piston (18) with the wall of the cylinder bore (20) of the housing block (12), the dimensions of the guide element (46) and the position of the abutment shoulders (48) of the receiving groove (44) are coordinated with one another in such a way that the guide element (46) radially projects in part into the guide gap (38) between the piston (18) and the wall of the cylinder bore (20) when it abuts with its rear side, which faces away from the piston, on these abutment shoulders (48).

Through the slot S, pressure medium enters the interior of the guide ring (46) that faces the piston (18). In addition, the pressure medium flows on the outside or laterally along the guide element (46) to the piston circumference and from there spreads toward the two seal assemblies (40a, b). The sealing lips of these seal assemblies (40a, b) that abut on the piston circumference, and the guide ring (46) are thereby lubricated, cause little frictional resistance on the piston (18), and are at most subject to little wear.

The sealing groove (42a) divides the cylinder bore (20) into a bore portion facing the working chamber (22) and into a bore portion facing away from the working chamber (22). The bore portion facing the working chamber may be designed to have a slightly larger inner diameter than the bore portion of the cylinder bore (20) that faces away from the working chamber, so that the guide gap (38) between the piston (18) and the wall of the cylinder bore (20) on the side facing the working chamber is somewhat larger and allows the piston (18), during its actuation, to take a certain oblique position relative to the longitudinal axis L, without the piston circumference coming into contact with the wall of the cylinder bore (20). The maximum oblique position of the piston (18) and thus the enlargement of the inner diameter of the cylinder bore (20) in the bore portion facing the working chamber is determined by the structural design of the guide ring (46) and the receiving groove (44) assigned thereto.

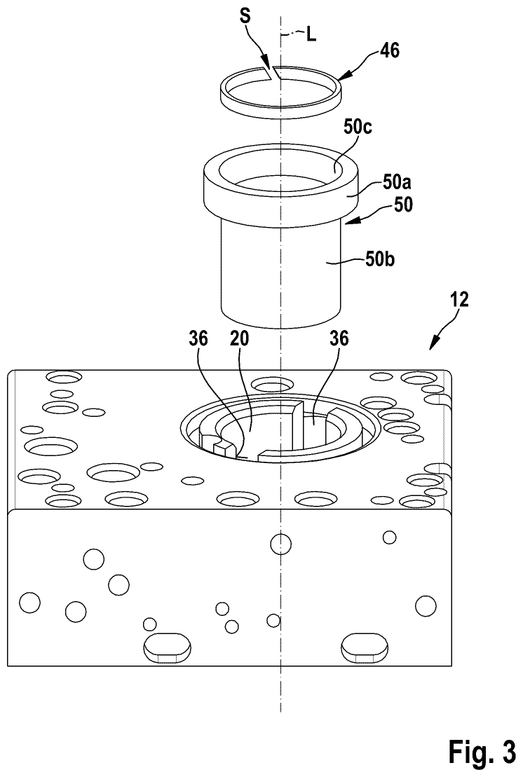

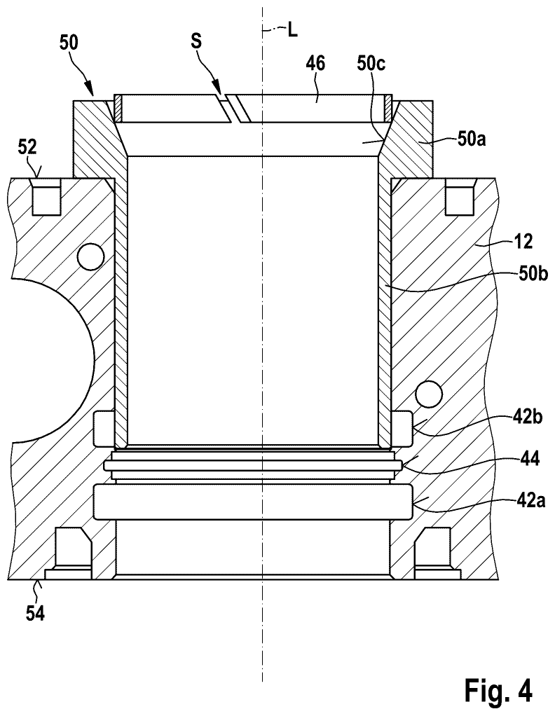

FIG. 3 and FIG. 4 illustrate the mounting operation of the guide element. FIG. 3 shows, in a three-dimensional exploded view, the already explained housing block (12) with a cylinder bore (20) formed therein for the piston (18) of a piston pressure generator (14), a mounting sleeve (50) offset once in its outer diameter, which mounting sleeve is provided in order to be able to be inserted into this cylinder bore (20), and finally the guide element (46) with the continuous slot S, which guide element is to be placed by means of the mounting sleeve (50) into the receiving groove (44) formed in the inner circumference of the cylinder bore (20). In the representation, the guide element (46) is in a relaxed state; the two free ends of the guide element (46) are opposite one another at a distance from one another, and the slot S oriented diagonally to the longitudinal axis L is thus open.

FIG. 4 shows a detailed enlargement of the portion of the housing block (12) with the cylinder bore (20) in a longitudinal section. This cylinder bore (20) penetrates the housing block (12) from a first flat or top side (52) up to a plane-parallel opposite second flat or bottom side (54) of this housing block (12). After successful production of the cylinder bore (20), three annularly circumferential grooves (42a, 42b, 44) have been formed in total along the inner wall of the cylinder bore (20) with a suitable tool. These three grooves (42a, 42b, 44) are arranged in a region of the cylinder bore (20) that is close to the bottom side, in each case at a mutual distance, when viewed in the direction of the longitudinal axis L of the cylinder bore (20). The two outer grooves (42a, 42b) have a rectangular cross section with continuous lateral flanks and are provided for accommodating the seal assemblies (40a, 40b) disclosed in connection with the description of FIG. 2.

The third annular groove or receiving groove (44) placed between the two outer annular grooves (42a, 42b) penetrates radially less deeply into the housing block (12) than the two outer annular grooves (42a, 42b) do. In cross section, it is offset once at a right angle, starting from the inner wall of the cylinder bore (20) radially outward and, when viewed in the direction of the longitudinal axis of the cylinder bore, is consequently divided into a wider first groove portion and a narrower second groove portion, which forms the groove bottom. Both groove portions transition into one another, wherein the transition is perpendicular, as explained, and thus forms circumferential abutment shoulders (48) concentric with the inner wall of the cylinder bore (20) (FIG. 2).

The mounting sleeve (50) is inserted into the cylinder bore (20) prepared in this way. Said mounting sleeve consists, for example, of a plastic material and, at one end, has a radially protruding flange (50a), with which it abuts flush on the top side (52) of the housing block (12). A shaft (50b) of the mounting sleeve (50) that adjoins the flange (50a) extends into the cylinder bore (20) and abuts flush on the wall thereof. The extent of the shaft (50b) is dimensioned in such a way that, when viewed in the insertion direction, the mounting sleeve (50) in the installed state ends behind the first annular groove (42b) for the first seal assembly (40b) and directly in front of the receiving groove (44) for the guide element (46).

An insertion slope (50c), the inner diameter of which continuously decreases from the outside to the interior of the mounting sleeve (50), is formed on the mounting sleeve (50) in the flange region. At the orifice to the surrounding area, the insertion slope (50c) has an inner diameter that is slightly larger than the outer diameter of a radially non-preloaded guide element (46). In this non-preloaded state, the free ends of the guide element are opposite one another at a slight distance from one another and the slot S through the guide element (46) is open.

If a punch or the like now acts from the outside on this guide element (46) with a force directed in the direction of the longitudinal axis L of the cylinder bore (20), this guide element (46) slides along the insertion slope and the mentioned slot S begins to close. Since the end faces of the ends of the guide element (46) are radially beveled in the same direction, they slide over one another as soon as they come into contact with one another, so that the outer dimension of the guide element (46) gradually decreases until it corresponds to the inner diameter of the mounting sleeve (50) in the region of the shaft (50b) thereof. At the same time, the guide element (46) is radially preloaded.

The thus preloaded guide element (46) is driven further along the shaft (50b) into the interior of the cylinder bore (20) and finally beyond the opposite end of this shaft (50b). As soon as the guide element (46) completely exits the mounting sleeve (50), the preload is relieved and the guide element (46) snaps into the provided receiving groove (44), which is formed directly at the end of the shaft (50b) of the mounting sleeve (50) on the wall of the cylinder bore (20).

With a remaining radial preload, the guide element (46) is circumferentially supported on the abutment shoulders (48) of the receiving groove (44) and projects in part via the opening of this receiving groove (44) into the interior of the cylinder bore (20), as shown in FIG. 2.

The punch and the mounting sleeve (50) are now no longer needed and can be removed from the housing block (12) or the cylinder bore (20).

Subsequently, the piston (18) is inserted, piston bottom first, into the cylinder bore (20). A transition from the piston bottom to the piston shaft is provided with a radius or a stage, whereby the piston (18) slightly widens and thus further preloads the guide element (46) as soon as it comes into engagement therewith. In a mounting end position, the guide element (46) is fixedly placed in the receiving groove (44). Here, it circumferentially encloses the piston (18) and radially supports this piston (18) in the cylinder bore (20) when the piston, driven by the transmission (16), moves back and forth in the cylinder bore (20).

Of course, changes or additions to the described exemplary embodiment are possible without leaving the scope of the present invention.

1-8. (canceled)

9. A hydraulic module for generating and/or controlling a brake pressure in a slip-controllable vehicle brake system, the hydraulic module comprising:
a housing block in which a cylinder bore is formed;
a piston of a piston pressure generator accommodated in the cylinder bore and delimiting a working chamber; and
a transmission by which the piston can be driven to perform an axial movement in a pressure increase direction and in a pressure decrease direction opposite to the pressure increase direction, wherein a volume of the working chamber decreases when the piston moves in the pressure increase direction, and increases when the piston is driven in the pressure lowering direction;
wherein a circumferential guide gap, which is sealed toward the working chamber by a seal assembly is arranged between a circumference of the piston and a wall of the cylinder bore; and
a guide element is provided on a side of the seal assembly that faces away from the working chamber, wherein, with the guide element, the piston can be circumferentially radially supported in the cylinder bore, wherein the guide element is accommodated in a receiving groove on the wall of the cylinder bore in such a way that the guide element projects radially in part into the guide gap.

10. The hydraulic module according to claim 9, wherein the guide element is a form-elastic, singly slotted annular element with two free and opposite ends.

11. The hydraulic module according to claim 9, wherein the guide element includes PTFE or a brake-fluid-resistant plastic.

12. The hydraulic unit according to claim 9, wherein the receiving groove is arranged between a first seal assembly directly facing the working chamber, and a second seal assembly far from the working chamber.

13. The hydraulic module according to claim 9, wherein the receiving groove is stepped in its cross section from an outside to an inside and forms inner abutment shoulders, on which the guide element can be radially supported.

14. The hydraulic module according to claim 13, wherein a groove portion of the receiving groove that is formed between the abutment shoulder and a groove bottom is connected to a pressure-medium-conducting cavity in the housing block.

15. The hydraulic module according to claim 9, wherein the guide element is accommodated with axial play in the receiving groove.

16. A mounting method for a hydraulic module, comprising the following steps:
providing a housing block having a cylinder bore formed therein, and a receiving groove for a guide element in an interior of this cylinder bore;
inserting a mounting sleeve into the cylinder bore;
inserting a guide element into the mounting sleeve; and
applying a directed propelling force in a direction of a longitudinal direction of the cylinder bore to the guide element until the guide element exits the mounting sleeve at an opposite end and snaps into the receiving groove.
